(19) United States
(12) Patent Application Publication
(10) Pub. No.: US 2011/0110111 A1
(43) Pub. Date: May 12, 2011

(54) LIGHT GUIDE UNIT OF LAMP FOR VEHICLE

(75) Inventor: Hyeong Woon RHO, Anyang-si (KR)

(73) Assignees: Hyundai Motor Company, Seoul (KR); Kia Motors Corporation, Seoul (KR)

(21) Appl. No.: 12/753,568

(22) Filed: Apr. 2, 2010

(30) Foreign Application Priority Data
Nov. 9, 2009 (KR) 10-2009-0107352

(51) Int. Cl. F21V 1/00

(52) U.S. Cl. 362/509

(57) ABSTRACT

A light guide unit of a lamp for a vehicle, may include a light guide having at least two guide bodies arranged in parallel in upper and lower directions respectively, and transfer portions extending from the at least two guide bodies respectively and being connected together to form a mount portion, and at least a LED mounted on the mount portion and aligned towards the at least two guide bodies together, wherein each focus of light ray of the at least a LED is disposed within an intersected area of the transfer portions such that the light emitted from the at least a LED is uniformly dispersed through the respective transfer portion and then transferred to the corresponding two guide bodies.

### CROSS-REFERENCE TO RELATED APPLICATION

The present application claims priority to Korean Patent Application No. 10-2009-0107352, filed on Nov. 9, 2009, the entire contents of which is incorporated herein for all purposes by this reference.

### BACKGROUND OF THE INVENTION

1. Field of the Invention

The present invention relates to a light guide unit of a lamp for a vehicle, and more particularly, to a light guide unit of a lamp for a vehicle, which can uniformly disperse and transfer light and can reduce a manufacturing cost.

2. Description of Related Art

Generally, headlights for securing a forward visual field at night driving and turn signal lamps for indicating left or right traveling direction of a vehicle are mounted on the front side of the vehicle, and rear combination lamps, in which brake lamps, tail lamps, turn signal lamps, and the like, are combined, are mounted on the rear side of the vehicle.

In the inside of a lamp for a vehicle, a light guide unit for guiding light from the lamp is mounted. A conventional light guide unit is illustrated in FIG. 1.

The conventional light guide unit 101 is roughly provided with three guide bodies 121, 122, and 123 arranged in parallel in upper and lower directions, and three LEDs 151, 152, and 153 arranged in parallel to the respective guide bodies 121, 122, and 123 to emit light to the respective guide bodies 121, 122, and 123.

In this case, as illustrated in FIG. 2A, the light emitted from the LEDs 151, 152, and 153 is guided along the guide bodies 121, 122, and 123, and thus the light flow shows light distribution as illustrated in FIG. 2B.

According to the light guide unit 101 as constructed above, the LEDs 151, 152, and 153 are arranged corresponding to the guide bodies 121, 122, and 123, respectively, and thus the light can be uniformly transferred to the guide bodies 121, 122, and 123. However, three LEDs 151, 152, and 153 are required to correspond to the number of guide bodies 121, 122, and 123, and thus the manufacturing cost is increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a light guide unit of a lamp for a vehicle, which can uniformly transfer light to guide bodies and can reduce a manufacturing cost.

In an aspect of the present invention, the light guide unit of a lamp for a vehicle, may include a light guide having at least two guide bodies arranged in parallel in upper and lower directions respectively, and transfer portions extending from the at least two guide bodies respectively and being connected together to form a mount portion, and at least a LED mounted on the mount portion and aligned towards the at least two guide bodies together, wherein each focus of light ray of the at least a LED is disposed within an intersected area of the transfer portions such that the light emitted from the at least a LED is uniformly dispersed through the respective transfer portion and then transferred to the corresponding two guide bodies.

In another aspect of the present invention, the light guide unit of a lamp for a vehicle, may include a light guide having a plurality of guide bodies arranged in parallel in upper, center, and lower directions, and a plurality of transfer portions extending from respective end parts of the plurality of guide bodies and connected together in a center to form an mount portion to transfer light to the plurality of guide bodies, and first and second LEDs mounted on the mount portion, wherein the first LED is aligned toward the guide bodies disposed in the upper and center direction together through the corresponding transfer portions and the second LED is aligned toward the guide bodies disposed in the center and lower direction together through the corresponding transfer portions, wherein the lights emitted from the first and second LEDs are uniformly dispersed through the plurality of transfer portions and then transferred to the plurality of guide bodies.

The foci of the first and second LEDs may be disposed in an intersected area of the plurality of transfer portions on the mounting portion.

The foci of the first and second LEDs may be aligned symmetric with respect to a center axis of the guide body positioned in the center direction.

The minimum length between distal ends and an intersected end of the plurality of transfer portions may be in a range between approximately 20 mm and approximately 30 mm in a horizontal direction.

The first LED may be arranged in a position that is spaced apart in a range between approximately 0.1 mm and approximately 0.5 mm from the upper transfer portion, and the second LED may be arranged in a position that is spaced apart in a range between approximately 0.1 mm and approximately 0.5 mm from the lower transfer portion.

According to the light guide unit as constructed above according to the present invention, even though only two LEDs are used, the light can be uniformly dispersed through the light guide and then transferred, and the manufacturing cost can be reduced.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view schematically illustrating a conventional light guide unit of a lamp for a vehicle.

FIG. 2A is a view illustrating the flow of diffused light of FIG. 1, and FIG. 2B is a view illustrating a state in which the light is distributed into the light guide of FIG. 1.

FIG. 3 is a view schematically illustrating an exemplary light guide unit of a lamp for a vehicle according to the present invention.

FIG. 4 is an enlarged view of a portion A in FIG. 3.

FIG. 5A is a view illustrating the flow of diffused light of FIG. 3, and FIG. 5B is a view illustrating a state in which the light is distributed into the light guide of FIG. 3.

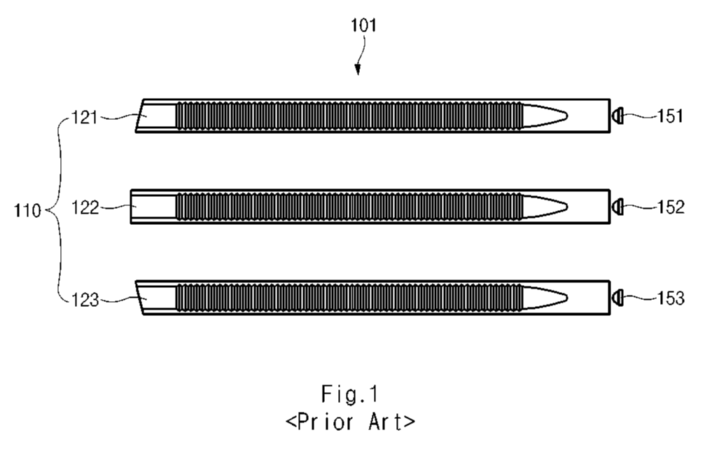

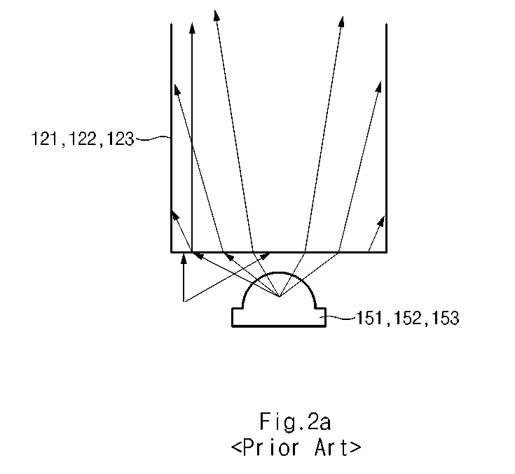

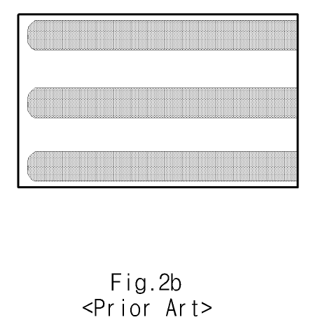

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent bodies of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

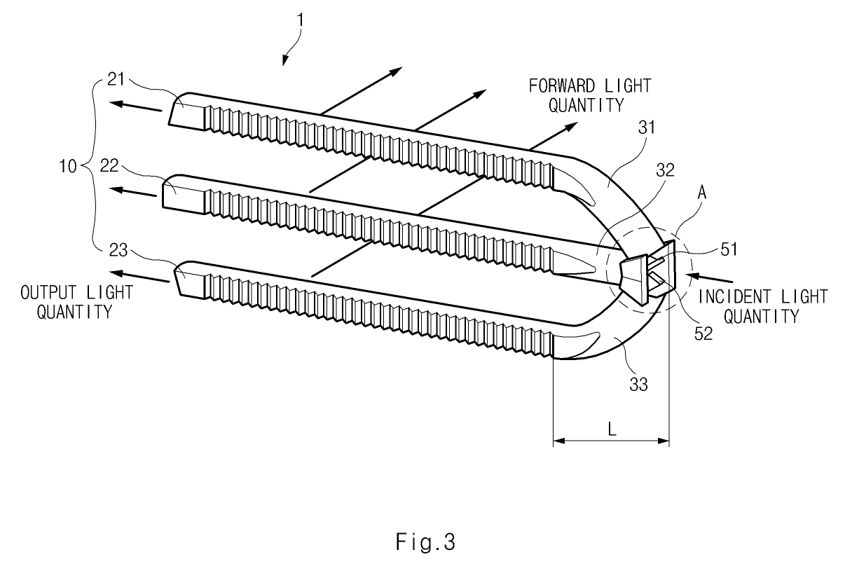

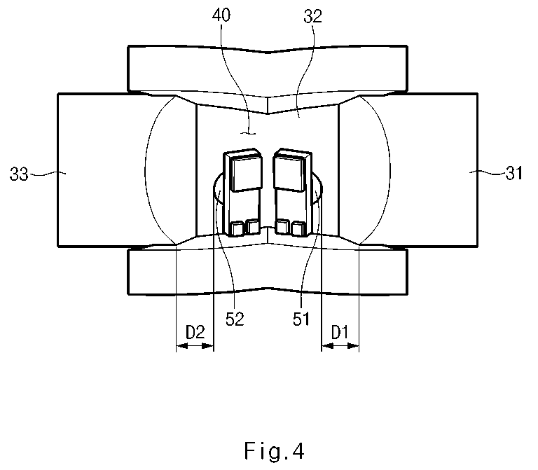

A light guide unit 1 of a lamp for a vehicle according to an exemplary embodiment of the present invention roughly includes, as illustrated in FIGS. 3 and 4, a light guide 10, and first and second LEDs 51 and 52 mounted on the light guide 10 to emit light.

The light guide 10 is in the form of a body, and includes a plurality of guide bodies 21, 22, and 23 arranged in parallel in upper and lower directions, and a plurality of transfer portions 31, 32, and 33 having a structure in which respective end portions of the respective guide bodies 21, 22, and 23 are concentrated into and connected together in a center to transfer light to the respective guide bodies 21, 2, and 23.

In the exemplary embodiment of the present invention, it is exemplified that three guide bodies 21, 22, and 23 and three transfer portions 31, 32, and 33 are provided. However, the number of guide bodies and the transfer portions are not limited thereto, and two, four or more guide bodies and transfer portions may be provided.

In a portion in which the plurality of transfer portions 31, 32, and 33 are connected together, a mount portion 40 is formed, and the first and second LEDs 51 and 52 for emitting light are mounted thereto.

Here, it is preferable that the minimum length L of the plurality of transfer portions 31, 32, and 33 is in the range of about 20 mm to 30 mm. By making the length of the transfer portions 31, 32, and 33 short, a compact light guide unit can be obtained.

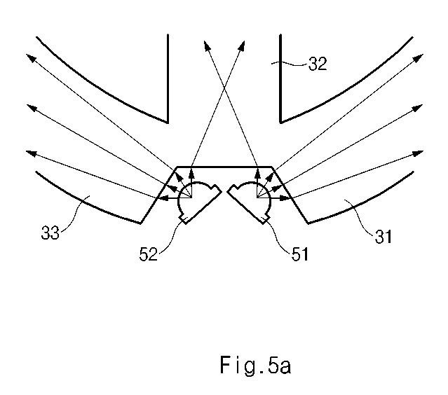

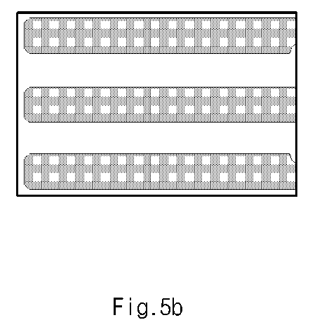

The first LED 51 is arranged toward an upper direction based on the guide body 22 positioned in the center, and the emitted light is uniformly dispersed through the uppermost and center transfer portions 31 and 32 in the center, as illustrated in FIGS. 5A and 5B, and then transferred to the respective guide bodies 21 and 22 connected thereto.

In this case, since the first LED 51 is arranged in a position that is spaced apart for a distance D1 in the range of about 0.1 mm to 0.5 mm from the uppermost transfer portion 31, and thus the emitted light is uniformly transferred up to ends of the uppermost guide body 21 and the center guide body 22.

The second LED 52 is arranged toward a lower direction based on the guide body 22 positioned in the center, and thus the emitted light is uniformly dispersed through the lowermost and center transfer portions 33 and 32 in the center, as illustrated in FIGS. 5A and 5B, and then transferred to the respective guide bodies 23 and 22 connected thereto.

In this case, since the second LED 52 is arranged in a position that is spaced apart for a distance D2 in the range of about 0.1 mm to 0.5 mm from the lowermost transfer portion 33, and thus the emitted light is uniformly transferred up to the ends of the lowermost guide body 23 and the center guide body 22.

Here, the dimensions, such as the thickness, width, and the like, of the respective guide bodies 21, 22, and 23 and the transfer portions 31, 32, and 33 should be optimally designed in a direction in which the light can uniformly be transferred.

As described above, according to the present invention, even though only two LEDs are used, the light can be uniformly dispersed through the light guide and then transferred, and the manufacturing cost can be reduced.

For convenience in explanation and accurate definition in the appended claims, the terms “upper”, “lower”, “uppermost”, and “lowermost” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A light guide unit of a lamp for a vehicle, comprising:
a light guide including:
at least two guide bodies arranged in parallel in upper and lower directions respectively; and
transfer portions extending from the at least two guide bodies respectively and being connected together to form a mount portion, and
at least a LED mounted on the mount portion and aligned towards the at least two guide bodies together,
wherein each focus of light ray of the at least a LED is disposed within an intersected area of the transfer portions such that the light emitted from the at least a LED is uniformly dispersed through the respective transfer portion and then transferred to the corresponding two guide bodies.

2. A light guide unit of a lamp for a vehicle, comprising:
a light guide including:
a plurality of guide bodies arranged in parallel in upper, center, and lower directions; and
a plurality of transfer portions extending from respective end parts of the plurality of guide bodies and connected together in a center to form an mount portion to transfer light to the plurality of guide bodies; and
first and second LEDs mounted on the mount portion, wherein the first LED is aligned toward the guide bodies disposed in the upper and center direction together through the corresponding transfer portions and the second LED is aligned toward the guide bodies disposed in the center and lower direction together through the corresponding transfer portions,
wherein the lights emitted from the first and second LEDs are uniformly dispersed through the plurality of transfer portions and then transferred to the plurality of guide bodies.

3. The light guide unit of claim 2, wherein the foci of the first and second LEDs are disposed in an intersected area of the plurality of transfer portions on the mounting portion.

4. The light guide unit of claim 2, wherein the foci of the first and second LEDs are aligned symmetric with respect to a center axis of the guide body positioned in the center direction.

5. The light guide unit of claim 2, wherein the minimum length between distal ends and an intersected end of the plurality of transfer portions is in a range between approximately 20 mm and approximately 30 mm in a horizontal direction.

6. The light guide unit of claim 5, wherein the first LED is arranged in a position that is spaced apart in a range between approximately 0.1 mm and approximately 0.5 mm from the upper transfer portion, and the second LED is arranged in a position that is spaced apart in a range between approximately 0.1 mm and approximately 0.5 mm from the lower transfer portion.

7. The light guide unit of claim 2, wherein the first LED is arranged in a position that is spaced apart in a range between approximately 0.1 mm and approximately 0.5 mm from the upper transfer portion, and the second LED is arranged in a position that is spaced apart in a range between approximately 0.1 mm and approximately 0.5 mm from the lower transfer portion.
